(19) United States
(12) Patent Application Publication
(10) Pub. No.: US 2026/0063775 A1
(43) Pub. Date: Mar. 5, 2026

(54) AUTOMATIC CALIBRATION METHOD BETWEEN CAMERA AND LIDAR, AND COMPUTER PROGRAM RECORDED ON RECORD-MEDIUM TO EXECUTE THE SAME

(71) Applicant: MOBILTECH, Seoul (KR)

(72) Inventors: Jae Seung KIM, Seoul (KR); Gil Hyeon GIM, Seongnam-si (KR); Sang Hun HAN, Seongnam-si (KR); Seung Jin PACK, Gwangju-si (KR)

(73) Assignee: MOBILTECH, Seoul (KR)

(21) Appl. No.: 19/289,930

(22) Filed: Aug. 4, 2025

(30) Foreign Application Priority Data
Sep. 3, 2024 (KR) 10-2024-0119046

(51) Int. Cl. G01S 7/497; G01S 17/894; G06T 7/11; G06T 7/77

(52) U.S. Cl. CPC G01S 7/497; G01S 17/894; G06T 7/11; G06T 7/77; G06T 2207/10028

(57) ABSTRACT

The present invention proposes a method for automatically performing calibration between a camera and a LiDAR using a calibration board. The method may include: detecting flat regions corresponding to the calibration board from each of two or more point cloud data acquired by a LiDAR; identifying regions corresponding to the calibration board from each of two or more images captured by a camera at the time the respective point cloud data was acquired, and matching the identified regions with the flat regions for estimating initial positions of the calibration board in three-dimensional coordinates; registering coordinates of the initial positions of the calibration board with coordinates of the flat regions; and determining a pose of the camera based on the registered coordinates.

### CROSS-REFERENCE TO RELATED APPLICATION

This application claims the benefit of Korean Patent Application No. 10-2024-0119046, filed on Sep. 3, 2024, in the Korean Intellectual Property Office, the disclosure of which is incorporated herein in its entirety by reference.

### TECHNICAL FIELD

The present invention relates to calibration between a LiDAR and cameras. More specifically, the present invention relates to a method for automatically performing calibration between a LiDAR and cameras using a calibration board, and to a computer program recorded on a storage medium for executing the method.

### BACKGROUND

Simultaneous Localization and Mapping (SLAM) is an algorithm capable of performing localization and mapping simultaneously.

Simultaneous Localization and Mapping (SLAM) is categorized into various types depending on the type of data used as the basis for localization and mapping. These include Visual SLAM (VSLAM), Monocular VSLAM, Stereo Camera VSLAM, RGB-D VSLAM, LiDAR SLAM, and RADAR SLAM. In addition, SLAM can also be classified according to the type of implementation algorithm, such as Extended Kalman Filter SLAM (EKF SLAM), Feature from Accelerated Segment Test SLAM (FAST SLAM), Graph-based SLAM, Oriented Fast and Rotated Brief SLAM (ORB SLAM), Large Scale Direct Monocular SLAM (LSD SLAM), and Visual Odometry with Deep Recurrent Convolutional Neural Networks (DeepVO).

Such SLAM techniques can be implemented based on data collected by various sensors including Light Detection and Ranging (LiDAR), cameras, Inertial Measurement Units (IMUs), and other types of sensors, and are utilized in a variety of tasks such as path planning, path following, object tracking, and sensor fusion.

However, various sensors used to acquire, capture, or measure data for SLAM cannot be physically installed at exactly the same single point. Therefore, in order to perform SLAM based on the data acquired, captured, or measured by these sensors, calibration of the acquired, captured, or measured data must be performed in advance.

### SUMMARY

The present invention proposes a method for automatically performing calibration between a camera and a LiDAR using a calibration board. The method may include: acquiring, by a map generation device, a plurality of point cloud data obtained by a LiDAR with respect to a calibration board, and detecting, from each of the point cloud data, a flat region corresponding to the calibration board; identifying, by the map generation device, from a plurality of images respectively captured by a camera at the time of acquiring the point cloud data, a region corresponding to the calibration board in each image, and estimating, for each image, an initial position of the calibration board in three-dimensional space by matching the identified region corresponding to the calibration board with the flat region; registering, by the map generation device, coordinates of the initial positions of the calibration board with coordinates of the flat regions; and determining, by the map generation device, a pose of the camera based on the registered coordinates.

The present invention proposes a computer program recorded on a storage medium for executing a method of automatically performing calibration between a camera and a LiDAR using a calibration board. The computer program may be combined with a computing device comprising a memory, a transceiver, and a processor configured to process instructions stored in the memory.

The processor is configured to: detect, for a calibration board, flat regions corresponding to the calibration board from each of a plurality of point cloud data acquired by a LiDAR; identify, from a plurality of images respectively captured by a camera at the times the point cloud data are acquired, regions corresponding to the calibration board in each image, and estimate an initial position of the calibration board in three-dimensional space for each image by matching the identified regions with the flat regions; register coordinates of the initial positions of the calibration board with coordinates of the flat regions; and determine a pose of the camera based on the registered coordinates.

### BRIEF DESCRIPTION OF THE DRAWINGS

FIG. 1 is a block diagram illustrating a configuration of a mapping system according to an embodiment of the disclosure.

FIG. 2 is a logical block diagram illustrating a configuration of a map generation device according to an embodiment of the disclosure.

FIGS. 3 and 4 are example diagrams for explaining a process of performing calibration between LiDARs according to an embodiment of the disclosure.

FIGS. 5 to 8 are example diagrams for explaining a process of performing calibration between a camera and a LiDAR according to an embodiment of the disclosure.

FIGS. 9 and 10 are example diagrams for explaining a process of estimating and optimizing parameters of a camera according to an embodiment of the disclosure.

FIG. 11 is a block diagram illustrating a hardware configuration of a map generation device according to an embodiment of the disclosure.

FIG. 12 is a flowchart for explaining a mapping method according to an embodiment of the disclosure.

FIG. 13 is a flowchart for explaining a method of calibrating between LiDARs according to an embodiment of the disclosure.

FIG. 14 is a flowchart for explaining a method of calibrating between a camera and a LiDAR according to an embodiment of the disclosure.

FIG. 15 is a flowchart for explaining a method of estimating and optimizing camera parameters according to an embodiment of the disclosure.

### DETAILED DESCRIPTION

The technical terms used in this specification are employed only for the purpose of describing specific embodiments and are not intended to limit the scope of the present disclosure. In addition, unless otherwise defined herein, the technical terms used in this specification should be interpreted as having meanings that are generally understood by those skilled in the art to which the present disclosure pertains, and should not be interpreted in an excessively broad or excessively narrow sense. Moreover, if any of the technical terms used in this specification are found to be inaccurate in expressing the spirit of the present disclosure, such terms should be replaced and interpreted as technical terms that can be correctly understood by those skilled in the art.

Further, general terms used in the present disclosure should be interpreted according to definitions provided in publicly available dictionaries or based on the context in which they are used, and should not be interpreted in an unduly limited manner.

Singular expressions used in this specification are intended to include plural forms unless the context clearly indicates otherwise. In this application, the terms such as “comprise” or “have” should not be interpreted as necessarily including all elements or steps described in the specification, and may include some of those elements or steps or may further include additional elements or steps.

Terms that include ordinal numbers, such as first and second, may be used to describe various elements but should not be construed as limiting the elements by those terms. These terms are only used to distinguish one element from another. For example, a first element may be referred to as a second element without departing from the scope of the present disclosure, and similarly, a second element may be referred to as a first element.

When an element is described as being “connected to” or “coupled to” another element, it may be directly connected or coupled to that element, or other elements may be interposed therebetween. On the other hand, when an element is described as being “directly connected to” or “directly coupled to” another element, no other elements are interposed between them.

Hereinafter, preferred embodiments of the present disclosure will be described in detail with reference to the accompanying drawings. In this case, the same reference numerals are assigned to the same or similar components regardless of the drawing in which they appear, and redundant descriptions thereof will be omitted. In addition, when explaining the present disclosure, a detailed description of known related technologies may be omitted when it is determined that such description would obscure the gist of the present disclosure.

The accompanying drawings are provided merely to assist in understanding the spirit of the present disclosure and should not be construed as limiting the scope of the present disclosure. The scope of the present disclosure should be interpreted to extend to all modifications, equivalents, and substitutions beyond the drawings.

An object of the present invention is to provide a method for automatically performing calibration between a camera and a LiDAR using a calibration board.

Another object of the present invention is to provide a computer program recorded on a storage medium for executing a method of automatically performing calibration between a camera and a LiDAR using a calibration board.

The technical problems addressed by the present invention are not limited to those mentioned above, and other technical problems not explicitly described will be clearly understood by those skilled in the art from the following description.

According to embodiments of the present invention, the pose of the camera can be automatically estimated, thereby enabling calibration between the camera and the LiDAR.

The effects of the present invention are not limited to those mentioned above, and other effects not explicitly described will be clearly understood by those skilled in the art from the claims.

Various sensors used to acquire, capture, or measure data for mapping cannot be physically installed at exactly the same single point. Therefore, in order to perform mapping based on the data acquired, captured, or measured by the different sensors, calibration of the acquired, captured, or measured data must be performed in advance.

The present disclosure proposes various approaches that can effectively perform calibration of the devices and data used for mapping.

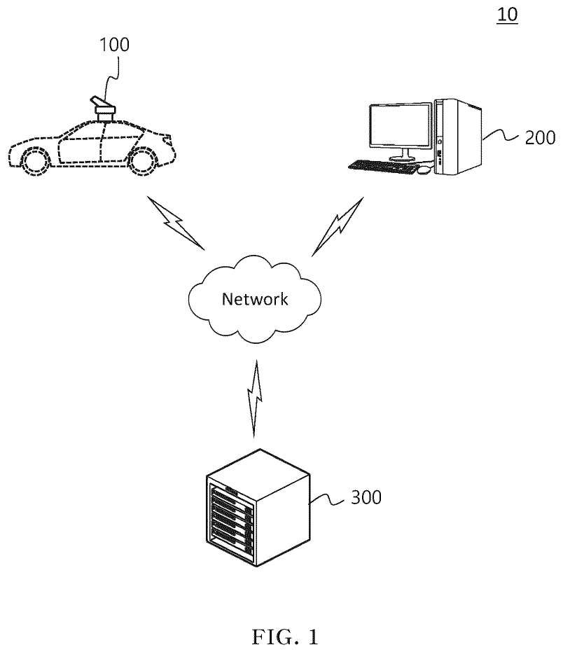

FIG. 1 is a block diagram illustrating a configuration of a mapping system according to an embodiment of the disclosure.

Referring to FIG. 1, a mapping system 10 according to an embodiment of the disclosure may include a data acquisition device 100, a map generation device 200, and a map application device 300.

The components of the mapping system 10 according to the embodiment are merely illustrative of functionally distinguishable elements. In an actual physical environment, two or more components may be implemented in an integrated manner, or a single component may be implemented in a separated manner.

Each component is described in detail as follows. The data acquisition device 100 may be mounted on a mobile platform and may collect data required for mapping. For example, the data acquisition device 100 may be mounted on a vehicle, an aircraft, or a drone to collect data necessary for mapping.

To this end, the data acquisition device 100 may include at least one of a LiDAR, a camera, a radar, an Inertial Measurement Unit (IMU), and a GPS receiver. Additionally, the data acquisition device 100 may further include various sensors capable of collecting information required for high-precision mapping, without being limited thereto.

In more detail, the LiDAR of the data acquisition device 100 may emit laser pulses in the surroundings and detect light reflected from objects located in the surroundings, thereby generating point cloud data corresponding to a three-dimensional image of the environment.

The camera of the data acquisition device 100 may capture images of the environment. The camera may be one of a color camera, a Near InfraRed (NIR) camera, a Short Wavelength InfraRed (SWIR) camera, or a Long WaveLength InfraRed (LWIR) camera, but is not limited thereto.

The Inertial Measurement Unit (IMU) of the data acquisition device 100 may include an acceleration sensor and a gyroscope, and may optionally include a magnetometer. The IMU may measure acceleration and angular velocity corresponding to the movement of the mobile platform on which the data acquisition device 100 is installed.

The GPS receiver may generate location coordinates of the data acquisition device 100 by triangulating multiple signals received from satellites.

The data acquisition device 100 may transmit the collected data to one or more of the map generation device 200 and the map application device 300.

As the next component, the map generation device 200 may generate a map by using the data collected by the data acquisition device 100.

In particular, the map generation device 200 according to various embodiments of the disclosure may perform calibration of point cloud data and images acquired or captured by a LiDAR and a camera, or may perform estimation and optimization of various parameters related to the camera.

Although this specification describes the calibration process of point cloud data and images, and the parameter estimation and optimization process separately, it will be apparent to those skilled in the art that these processes may be performed either in parallel or sequentially.

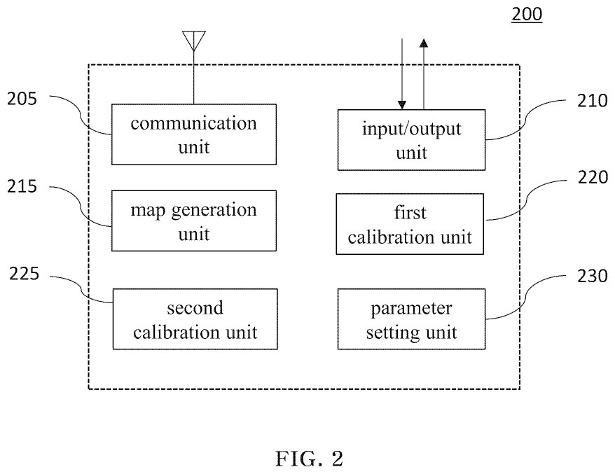

Details on the specific configuration and operations of the map generation device 200 according to various embodiments of the disclosure will be described later with reference to FIGS. 2 through 15.

As the next component, the map application device 300 may directly apply the map generated by the map generation device 200 to various application domains or may process the map for such applications.

For example, the map application device 300 may be a device that performs a Location-Based Service (LBS) based on the map generated by the map generation device 200. Alternatively, the map application device 300 may be a device that adds metadata regarding objects included in the map generated by the map generation device 200 or performs operations for detecting objects contained within the map.

As described above, the map generation device 200 and the map application device 300 may be implemented by any type of device capable of transmitting and receiving data and performing computations based on the transmitted or received data. For example, the map generation device 200 and the map application device 300 may be any one of fixed computing devices, such as a desktop computer, a workstation, or a server, but are not limited thereto.

In addition, the data acquisition device 100, the map generation device 200, and the map application device 300 may transmit and receive data via a network comprising one or more of a secure dedicated line, a public wired communication network, or a mobile communication network that connects the devices directly.

For example, the public wired communication network may include Ethernet, xDSL (x Digital Subscriber Line), Hybrid Fiber Coax (HFC), or Fiber To The Home (FTTH), but is not limited thereto. The mobile communication network may include Code Division Multiple Access (CDMA), Wideband CDMA (WCDMA), High Speed Packet Access (HSPA), Long Term Evolution (LTE), or 5th/6th generation mobile telecommunication, but is not limited thereto.

Hereinafter, the configuration of the map generation device 200 as described above will be described in more detail.

FIG. 2 is a logical block diagram illustrating a configuration of a map generation device according to an embodiment of the disclosure.

Referring to FIG. 2, a map generation device 200 according to various embodiments of the disclosure may include a communication unit 205, an input/output unit 210, a map generation unit 215, a first calibration unit 220, a second calibration unit 225, and a parameter setting unit 230.

These components of the map generation device 200 represent functionally distinguishable units. In an actual physical environment, two or more components may be implemented in an integrated manner, or a single component may be implemented in a separated manner.

Each component is described in detail as follows. The communication unit 205 may transmit and receive data to and from the data acquisition device 100 and the map application device 300.

Specifically, the communication unit 205 may receive mapping-related data from the data acquisition device 100. The mapping-related data may include one or more of point cloud data, images, acceleration and angular velocity, and position coordinates, but is not limited thereto. The communication unit 205 may also transmit a generated map to the map application device 300.

The input/output unit 210 may receive signals from a user through a user interface (UI), or output computation results externally.

The input/output unit 210 may output mapping-related data received from the data acquisition device 100. The input/output unit 210 may receive various configuration values for calibrating point cloud data and images. The input/output unit 210 may also output the calibrated point cloud data and images, as well as the estimated and optimized camera parameters.

The map generation unit 215 may generate a map based on data collected by the data acquisition device 100.

Specifically, the map generation unit 215 may generate a map based on Simultaneous Localization and Mapping (SLAM) or based on a Mobile Mapping System (MMS).

According to one embodiment, a process by which the map generation unit 215 generates a map based on SLAM is described. First, the map generation unit 215 may receive data collected by the data acquisition device 100 via the communication unit 205. The map generation unit 215 may parse the received time-series point cloud data acquired continuously by the LiDAR. The map generation unit 215 may then register the parsed point cloud data. Based on the registered point cloud data, the map generation unit 215 may generate Global Navigation Satellite System (GNSS) data. By repeatedly parsing and registering point cloud data acquired for more than 10 seconds and generating GNSS data, the map generation unit 215 may perform SLAM.

The first calibration unit 220 may perform calibration between multiple LiDARs. More specifically, the first calibration unit 220 may perform calibration of a plurality of LiDARs based on a pre-generated map.

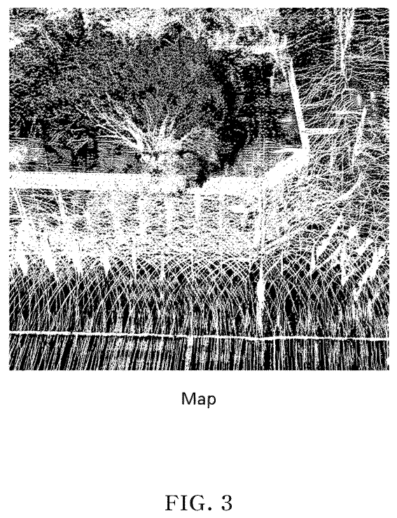

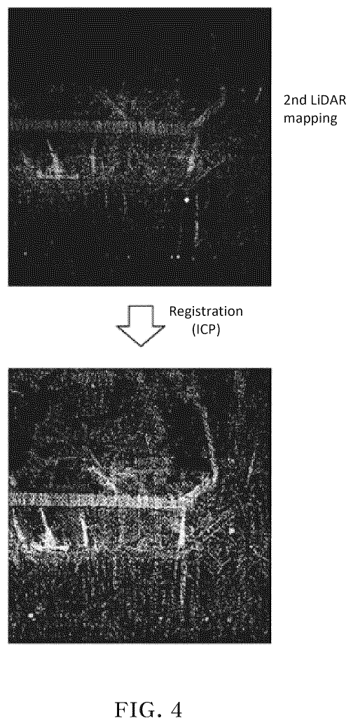

For further explanation of the first calibration unit 220, reference is made to FIGS. 3 and 4.

FIGS. 3 and 4 are example diagrams for explaining a process of performing calibration between LiDARs according to an embodiment of the disclosure.

First, as illustrated in FIG. 3, the first calibration unit 220 may acquire a pre-generated map through the map generation unit 215. Here, the pre-generated map may be a map created by Simultaneous Localization and Mapping (SLAM) based on point cloud data collected by a first LiDAR of the data acquisition device 100. However, the pre-generated map is not limited to SLAM-based mapping and may also be a map generated by a Mobile Mapping System (MMS).

As shown in FIG. 4, the first calibration unit 220 may map point cloud data collected by a second LiDAR onto the pre-generated map. In this case, the first LiDAR used for generating the map and the second LiDAR from which the point cloud data to be mapped was collected may be LiDAR sensors fixed at different positions on the same mobile platform.

The first and second LiDARs may collect point cloud data while rotating in different directions. For example, the first LiDAR may rotate in a direction parallel to the ground to collect point cloud data, while the second LiDAR may rotate in a direction perpendicular to the ground to collect point cloud data. However, these orientations are not limiting. Therefore, before mapping the point cloud data collected by the second LiDAR onto the pre-generated map, the first calibration unit 220 may rotate the coordinates of the second LiDAR's point cloud data in three-dimensional space in accordance with the angular difference between the rotation of the first and second LiDARs.

The first calibration unit 220 may register the point cloud data collected by the second LiDAR so that the point cloud data collected by the second LiDAR corresponds to the pre-generated map. More specifically, the first calibration unit 220 may use an Iterative Closest Point (ICP) algorithm to perform registration between the pre-generated map and the point cloud data collected by the second LiDAR. Based on the registration results, the first calibration unit 220 may update the pose of the second LiDAR. That is, the first calibration unit 220 may update the rotation matrix (R) and the translation matrix (T) of the second LiDAR based on the registration result.

In consideration of motion changes of the second LiDAR over time, the first calibration unit 220 may perform motion correction of the second LiDAR, then map newly collected point cloud data from the second LiDAR onto the pre-generated map, perform registration, and update the second LiDAR's pose based on the registration results. This process may be repeated.

The iterative process of the first calibration unit 220 may continue until the Root Mean Square (RMS) error between the registered point cloud data and the pre-generated map becomes smaller than a predefined threshold.

For example, the first calibration unit 220 may repeat the process of motion correction, mapping, registration, and pose update of the second LiDAR until the RMS error falls below 0.1.

Here, the motion correction of the second LiDAR performed by the first calibration unit 220 may involve compensation based on roll, pitch, and yaw rotations applied to the second LiDAR mounted on the mobile platform over time, in order to achieve more accurate pose estimation.

Meanwhile, the first calibration unit 220 may reduce computational load caused by the above-described iterative operations by performing sub-sampling based on time or motion for the entire point cloud data collected by the second LiDAR, and repeating the calibration process only for the sub-sampled data.

For example, the first calibration unit 220 may sample only point cloud data collected at time points where motion correction of the second LiDAR exceeds a predefined threshold. Alternatively, the first calibration unit 220 may sample only point cloud data collected by the second LiDAR at predefined time intervals.

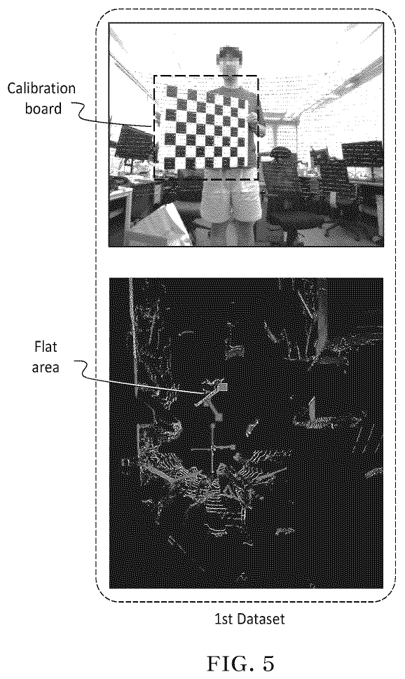

Next, the second calibration unit 225 may perform calibration between a camera and a LiDAR. More specifically, the second calibration unit 225 may automatically estimate the pose of the camera and perform calibration between the camera and the LiDAR based on the estimated pose. For explanation of the second calibration unit 225, reference is made to FIGS. 5 through 8.

FIGS. 5 to 8 are example diagrams for explaining a process of performing calibration between a camera and a LiDAR according to an embodiment of the disclosure.

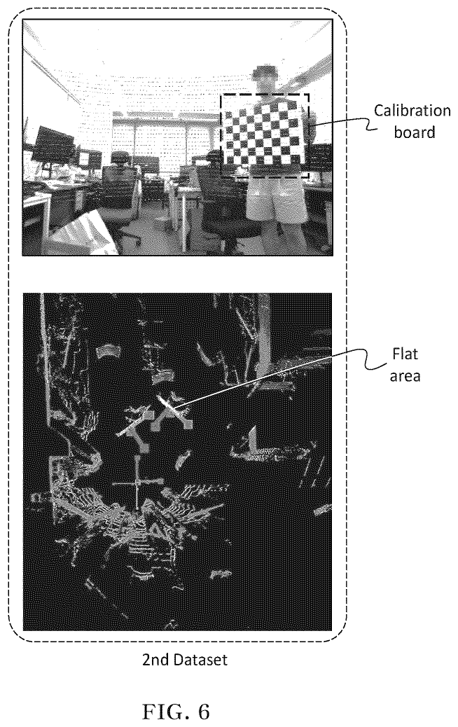

First, as illustrated in FIGS. 5 and 6, the LiDAR and camera of the data acquisition device 100 may acquire point cloud data and capture images, respectively, while remaining stationary, with respect to a calibration board whose position changes over time. The point cloud data and images thus acquired and captured may be grouped as a single dataset based on the time of acquisition or capture by the LiDAR and the camera. Here, the calibration board may be referred to as a checkerboard or chessboard.

The second calibration unit 225 may detect flat regions corresponding to the calibration board from each of two or more point cloud data acquired by the LiDAR. More specifically, the second calibration unit 225 may select two or more point cloud data respectively from two or more datasets formed at different time points in a time series. In this case, to ensure that the calibration board is static, the second calibration unit 225 may select only point cloud data acquired simultaneously with images that do not contain motion blur of the calibration board.

The second calibration unit 225 may perform Boolean operations between the selected point cloud data to detect flat regions from each. Furthermore, the second calibration unit 225 may apply a RANSAC (Random Sample Consensus) algorithm to the result of the Boolean operations to extract only coordinates corresponding to the flat regions.

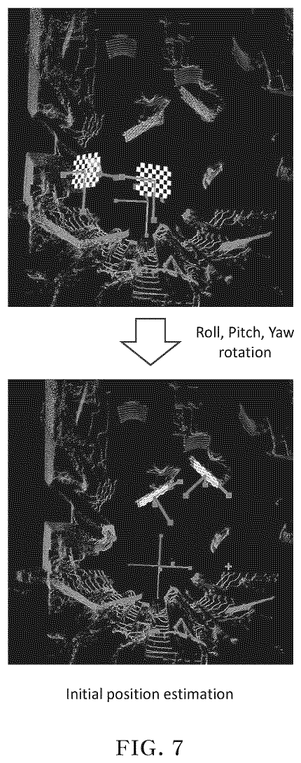

Subsequently, as illustrated in FIG. 7, the second calibration unit 225 may identify, from each of a plurality of images captured by the camera at the time the respective point cloud data was acquired, regions corresponding to the calibration board. In other words, each of the point cloud data and images targeted by the second calibration unit 225 constructs a single dataset.

The second calibration unit 225 may match the region corresponding to the calibration board, identified from the image, with the flat region detected from the point cloud data. More specifically, the second calibration unit 225 may perform a three-dimensional rotation of the region corresponding to the calibration board so that the region corresponding to the calibration board overlaps maximally with the flat region. For example, the second calibration unit 225 may rotate the region corresponding to the calibration board by varying the roll, pitch, and yaw angles from 1 degree to 360 degrees to maximize overlap with the flat region.

Based on the matching result between the region corresponding to the calibration board and the flat region of the point cloud data, the second calibration unit 225 may estimate the initial position of the calibration board in three-dimensional space. To this end, the second calibration unit 225 may calculate the center of gravity of the flat region in the state in which the region corresponding to the calibration board is rotated to overlap the flat region. Then, based on the calculated center of gravity, the second calibration unit 225 may estimate the initial position of the calibration board.

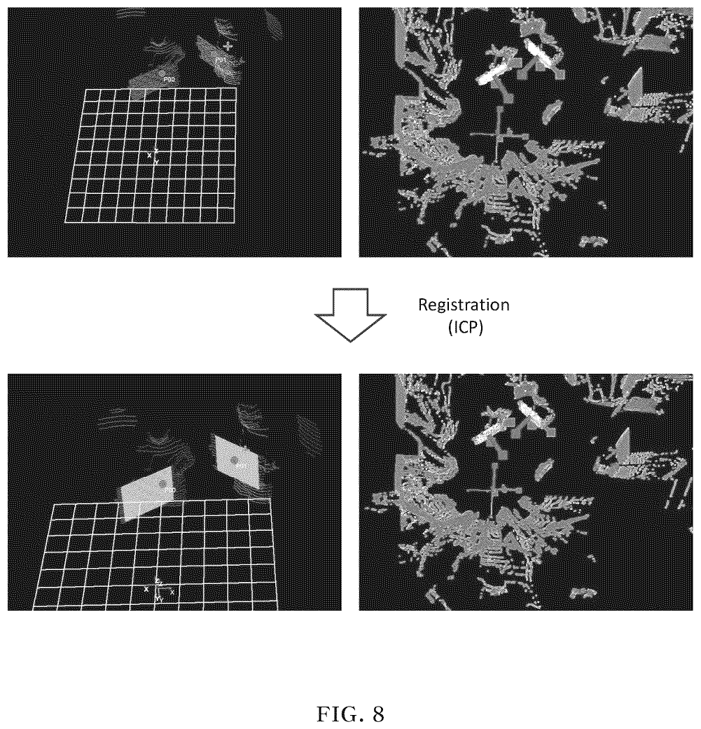

As illustrated in FIG. 8, the second calibration unit 225 may register the coordinates of the initial position of the calibration board with the coordinates of the flat region. More specifically, the second calibration unit 225 may use an Iterative Closest Point (ICP) algorithm to perform this registration.

Distinctively, to reduce the computational load of the registration process, the second calibration unit 225 may selectively register only the coordinates corresponding to the four corners of the calibration board and the flat region. Furthermore, during the selective registration of the four corner coordinates, the second calibration unit 225 may calculate an error rate between the coordinates of the calibration board and those of the flat region. If the calculated error rate exceeds a predefined threshold, the second calibration unit 225 may proceed to register the entire set of coordinates of both the initial position of the calibration board and the flat region.

Based on the registered coordinates, the second calibration unit 225 may determine the pose of the camera. Specifically, the second calibration unit 225 may calculate a rotation matrix and a translation matrix (RT) of the camera based on the registered coordinates. If only the four corner coordinates were selectively registered, the second calibration unit 225 may calculate the camera's rotation and translation matrices (RT) based solely on those four matched coordinates.

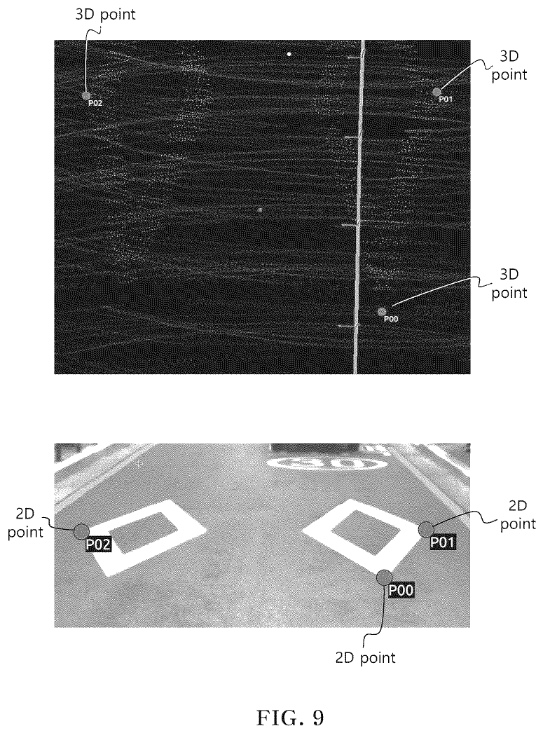

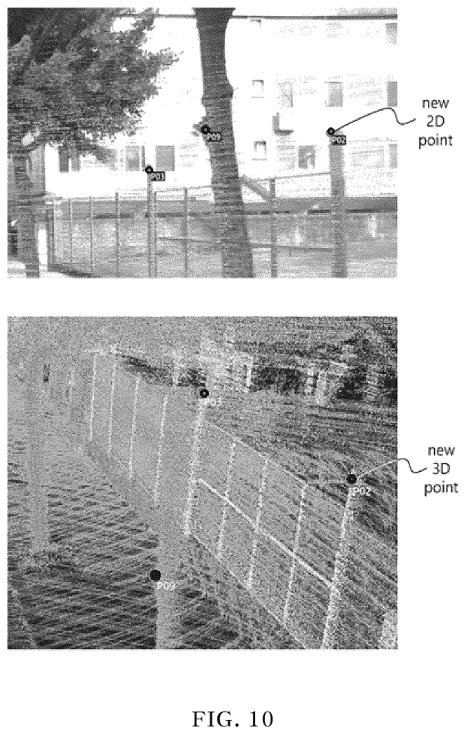

Next, the parameter setting unit 230 may estimate and optimize extrinsic parameters and intrinsic parameters of the camera. Here, the extrinsic parameters may include a rotation matrix and a translation matrix (RT) that represent the position and orientation of a camera fixed to a mobile platform. The intrinsic parameters may include a focal length and an optical center, which are determined by the lens and sensor of the camera. For further explanation of the parameter setting unit 230, reference is made to FIGS. 9 and 10.

FIGS. 9 and 10 are example diagrams for explaining a process of estimating and optimizing camera parameters according to an embodiment of the disclosure.

The parameter setting unit 230 may acquire a pre-generated map through the map generation unit 215. The map generated by the map generation unit 215 may be based on point cloud data and images respectively acquired and captured by the LiDAR and camera installed on the same mobile platform.

As illustrated in FIG. 9, the parameter setting unit 230 may select a three-dimensional (3D) point from the point cloud data constructing the map and a two-dimensional (2D) point from the images constructing the map. In this case, the selected 3D point and 2D point may correspond to the same physical location.

In particular, the parameter setting unit 230 may select three 3D points and three 2D points respectively from the point cloud data and the images, such that each pair of points indicates the same three locations.

This selection process of 3D and 2D points may be performed either manually or automatically. More specifically, the parameter setting unit 230 may select the 3D and 2D points based on reference values input by a user via the input/output unit 210.

Alternatively, the parameter setting unit 230 may perform feature detection on the point cloud data and the images. For example, the parameter setting unit 230 may use one of SIFT (Scale-Invariant Feature Transform), SURF (Speeded-Up Robust Features), ORB (Oriented FAST and Rotated BRIEF), FAST (Features from Accelerated Segment Test), BRISK (Binary Robust Invariant Scalable Keypoints), or AKAZE (Accelerated-KAZE) to perform feature detection. Then, the parameter setting unit 230 may compare feature descriptors for interest points detected from the point cloud data and keypoints detected from the image. If the descriptors are determined to correspond to the same location, the 3D and 2D points corresponding to the matched interest points may be selected.

For example, brute-force matching or k-Nearest Neighbor (k-NN) may be used to determine whether the detected features indicate the same location.

Subsequently, the parameter setting unit 230 may estimate the extrinsic parameters of the camera based on the condition that the selected three-dimensional (3D) points are projected onto the corresponding two-dimensional (2D) points.

More specifically, the parameter setting unit 230 may construct a matrix for transforming world coordinates of the 3D points into camera coordinates of the 2D points. Here, the world coordinate system is an independent coordinate system used to represent the position of an object with respect to an absolute origin in three-dimensional space. The camera coordinate system is a coordinate system used to represent the position of an object with respect to the center of the camera in three-dimensional space. Based on the constructed matrix, the parameter setting unit 230 may estimate the extrinsic parameters of the camera.

For example, to transform a world coordinate point P(U,V,W) of a 3D point into a camera coordinate point (X,Y,Z) of a 2D point, the parameter setting unit 230 may construct the following matrix:

$$[ \begin{matrix}X \\ Y \\ Z\end{matrix} ] = [ \begin{matrix}{r}_{00} & {r}_{01} & {r}_{02} & {t}_{x} \\ {r}_{10} & {r}_{11} & {r}_{12} & {t}_{y} \\ {r}_{20} & {r}_{21} & {r}_{22} & {t}_{z}\end{matrix} ] [ \begin{matrix}U \\ V \\ W \\ 1\end{matrix} ]$$

The parameter setting unit 230 may estimate the extrinsic parameters of the camera based on the rotation values r₀₀, r₀₁, r₀₂, r₁₀, r₁₁, r₁₂, r₂₀, r₂₁, r₂₂ and the translation values tₓ, t_{y}, t_{z} included in the constructed matrix.

The parameter setting unit 230 may, when three 3D points and three 2D points are selected from the point cloud data and the image respectively, identify a single condition under which the three 3D points are projected onto the corresponding three 2D points. Based on the identified condition, the parameter setting unit 230 may estimate the extrinsic parameters of the camera.

If only two of the three 3D points are projected onto the corresponding two 2D points under the identified condition, and the remaining 3D point is not projected onto the corresponding 2D point, the parameter setting unit 230 may newly select another 3D point and 2D point from the point cloud data and the image, and verify whether the newly selected 3D point is projected onto the 2D point under the same condition.

Subsequently, the parameter setting unit 230 may estimate the intrinsic parameters of the camera based on the condition that a 2D point is projected onto the image plane.

More specifically, the parameter setting unit 230 may construct a matrix for converting the camera coordinates of a 2D point into image coordinates on the image. Here, the image coordinate refers to a coordinate that represents a pixel position in the two-dimensional image. Based on the constructed matrix, the parameter setting unit 230 may estimate the intrinsic parameters.

For example, to convert the camera coordinates (X,Y,Z) of a 2D point into image coordinates (x,y), the parameter setting unit 230 may construct the following matrix:

$$[ \begin{matrix}x \\ y \\ 1\end{matrix} ] = s [ \begin{matrix}{f}_{x} & 0 & {c}_{x} \\ 0 & {f}_{y} & {c}_{y} \\ 0 & 0 & 1\end{matrix} ] [ \begin{matrix}X \\ Y \\ Z\end{matrix} ]$$

The parameter setting unit 230 may estimate the intrinsic parameters of the camera based on the focal lengths fₓ, f_{y} and the optical center coordinates cₓ, c_{y} included in the constructed matrix. Meanwhile, s in the constructed matrix represents a scale factor.

Subsequently, as illustrated in FIG. 10, the parameter setting unit 230 may select new three-dimensional (3D) points and two-dimensional (2D) points from the point cloud data and the image. In this case, while it may be unclear whether the new 3D and 2D points indicate the exact same location, they may correspond to approximately the same position.

The parameter setting unit 230 may then optimize the previously estimated intrinsic parameters so that the new 2D points can be projected accurately onto the image plane.

To this end, the parameter setting unit 230 may use an algorithm related to non-linear least squares optimization to optimize the intrinsic parameters. For example, the parameter setting unit 230 may use the Levenberg-Marquardt method among non-linear least squares algorithms to optimize the intrinsic parameters. However, the optimization is not limited thereto, and the parameter setting unit 230 may alternatively use the Newton-Raphson method or the Gauss-Newton method for optimization.

Meanwhile, the parameter setting unit 230 may select new 3D and 2D points from the point cloud data and the image that indicate the same physical location. Based on the newly selected 3D and 2D points, the parameter setting unit 230 may verify the previously estimated extrinsic parameters and the optimized intrinsic parameters.

In addition, the parameter setting unit 230 may perform correction for coordinates that do not conform to the previously estimated extrinsic parameters and the optimized intrinsic parameters, using 3D and 2D points that were not previously selected from the point cloud data and the image.

As a result, based on the estimated and optimized extrinsic and intrinsic parameters, the parameter setting unit 230 may estimate the pose of the camera.

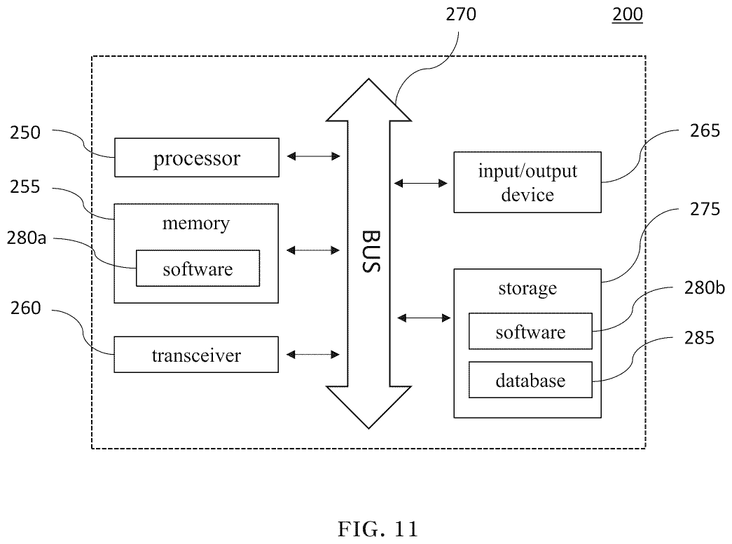

FIG. 11 is a hardware block diagram illustrating a configuration of a map generation device according to an embodiment of the disclosure.

Referring to FIG. 11, the map generation device 200 may include a processor 250, a memory 255, a transceiver 260, an input/output device 265, a data bus 270, and a storage 275.

The processor 250 may implement the operations and functions of the map generation device 200 based on instructions defined by software 280a that resides in the memory 255. The memory 255 may store software 280a implementing the method according to the present disclosure. The transceiver 260 may transmit and receive data to and from the data acquisition device 100 and the map application device 300.

The input/output device 265 may receive input data required for the operation of the map generation device 200 and output generated result values. The data bus 270 may be connected to the processor 250, memory 255, transceiver 260, input/output device 265, and storage 275, and may serve as a communication channel for transferring data between these components.

The storage 275 may store application programming interfaces (APIs), libraries, and resource files required to execute the software 280a implementing the method of the present disclosure. The storage 275 may also store software 280b implementing the method according to the present disclosure. Additionally, the storage 275 may store information necessary for performing the calibration method and the mapping method. In particular, the storage 275 may include a database 285 for storing a program for executing the calibration and mapping methods.

According to one embodiment of the disclosure, the software 280a or 280b, which is resident in the memory 255 or stored in the storage 275, may be a computer program recorded on a storage medium to execute the following steps: mapping, by the processor 250, point cloud data collected by a second LiDAR onto a pre-generated map; registering, by the processor 250, the point cloud data collected by the second LiDAR to correspond with the pre-generated map; updating, by the processor 250, a pose of the second LiDAR based on the registration result; and repeating a process in which, after motion correction is performed for the second LiDAR, newly collected point cloud data is mapped onto the pre-generated map, the mapped data is registered, and the pose of the second LiDAR is updated.

According to another embodiment of the disclosure, the software 280a or 280b, which is resident in the memory 255 or stored in the storage 275, may be a computer program recorded on a storage medium to execute the following steps: detecting, by the processor 250, flat regions corresponding to a calibration board from each of a plurality of point cloud data acquired by a LiDAR; identifying, by the processor 250, regions corresponding to the calibration board from a plurality of images respectively captured by a camera at the time the point cloud data was acquired, and matching the identified regions with the flat regions to estimate initial positions of the calibration board in three-dimensional space; registering, by the processor 250, the coordinates of the initial positions with the coordinates of the flat regions; and determining, by the processor 250, a pose of the camera based on the registered coordinates.

According to another embodiment of the present disclosure, the software 280a or 280b, which resides in the memory 255 or is stored in the storage 275, may be a computer program recorded on a storage medium for executing the following steps: generating, by the processor 250, a map based on point cloud data and images respectively acquired and captured by a LiDAR and a camera installed on the same mobile platform; selecting, by the processor 250, a three-dimensional (3D) point from the point cloud data and a two-dimensional (2D) point from the images constructing the generated map, such that the 3D and 2D points indicate the same physical location; and estimating, by the processor 250, extrinsic parameters of the camera based on the condition that the selected 3D point is projected onto the 2D point.

More specifically, the processor 250 may include an Application-Specific Integrated Circuit (ASIC), other chipsets, logic circuits, and/or data processing units. The memory 255 may include Read-Only Memory (ROM), Random Access Memory (RAM), flash memory, memory cards, storage media, and/or other storage devices. The transceiver 260 may include a baseband circuit for processing wired or wireless signals. The input/output device 265 may include input devices such as a keyboard, mouse, and/or joystick, and output devices such as a Liquid Crystal Display (LCD), Organic Light Emitting Diode (OLED), Active Matrix OLED (AMOLED), printer, plotter, and other image or print output devices.

When an embodiment of the present disclosure is implemented in software, the methods described above may be implemented as modules (i.e., procedures or functions) that perform the respective functions. These modules may reside in the memory 255 and may be executed by the processor 250. The memory 255 may be located either internally or externally to the processor 250 and may be connected by various known means.

Each component illustrated in FIG. 3 may be implemented by various means such as hardware, firmware, software, or any combination thereof. In the case of a hardware implementation, an embodiment of the present disclosure may be realized by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, or the like.

In the case of a firmware or software implementation, an embodiment of the present disclosure may be implemented in the form of modules, procedures, or functions that perform the functions or operations described above, and may be recorded on a computer-readable storage medium by various computer means. The storage medium may include program instructions, data files, data structures, or combinations thereof.

Program instructions recorded on the storage medium may be specifically designed and configured for the present disclosure, or may be known and available for use by those skilled in the art of computer software. For example, the storage medium may include magnetic media such as hard disks, floppy disks, and magnetic tapes; optical media such as CD-ROMs and DVDs; magneto-optical media such as floptical disks; and hardware devices such as ROM, RAM, and flash memory that are specifically configured to store and execute program instructions.

Examples of program instructions include not only machine code generated by a compiler, but also high-level language code that can be executed by a computer using an interpreter or the like. Such hardware devices may be configured to operate as one or more software modules for performing the operations of the present disclosure, and vice versa.

Hereinafter, the operations of the map generation device 200, as described above, will be explained in greater detail.

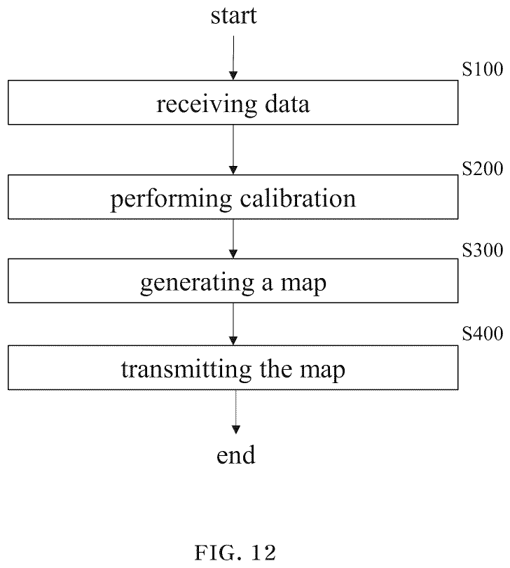

FIG. 12 is a flowchart for explaining a mapping method according to an embodiment of the disclosure.

As illustrated in FIG. 12, the map generation device 200 may receive data required for mapping from the data acquisition device 100 (S100).

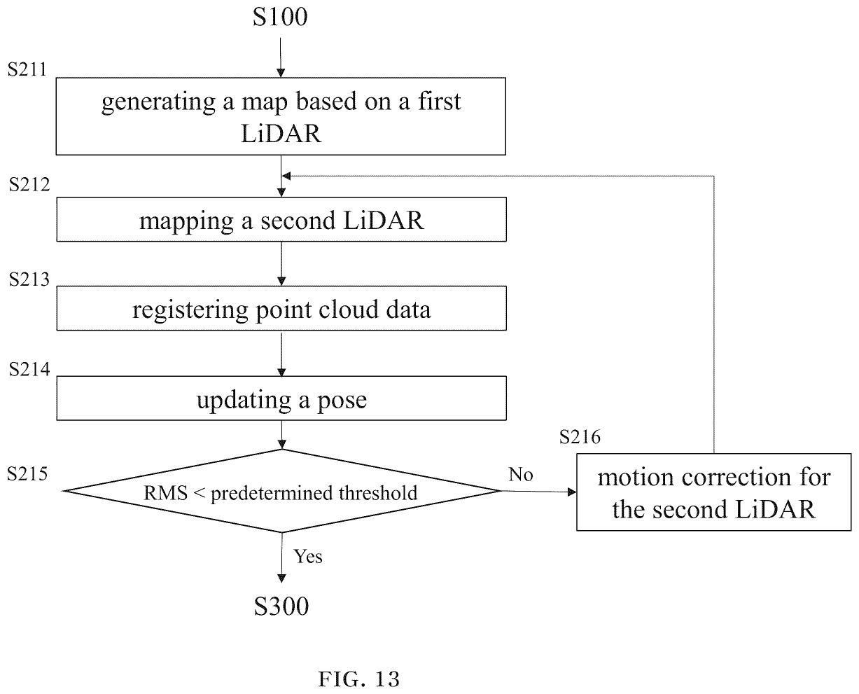

The map generation device 200 may perform calibration of point cloud data and images acquired or captured by the LiDAR and the camera, or may estimate and optimize various parameters related to the camera (S200). The specific calibration, parameter estimation, and optimization operations of the map generation device 200 will be described later with reference to FIGS. 13 through 15.

The map generation device 200 may generate a map based on the calibrated point cloud data and images, as well as the estimated and optimized camera parameters (S300). More specifically, the map generation device 200 may generate the map based on Simultaneous Localization and Mapping (SLAM) or a Mobile Mapping System (MMS).

Thereafter, the map generation device 200 may transmit the generated map to the map application device 300 (S400).

FIG. 13 is a flowchart for explaining a method of calibrating between LiDARs according to an embodiment of the disclosure.

As illustrated in FIG. 13, the map generation device 200 may generate a map using Simultaneous Localization and Mapping (SLAM) based on point cloud data collected by a first LiDAR (S211). However, this is not limiting, and the map generation device 200 may alternatively generate the map based on a Mobile Mapping System (MMS).

The map generation device 200 may map point cloud data collected by a second LiDAR onto the map generated based on the point cloud data from the first LiDAR (S212).

The map generation device 200 may register the point cloud data collected by the second LiDAR so that the point cloud data collected by the second LiDAR corresponds to the map generated based on the first LiDAR's data (S213). In this case, the map generation device 200 may use the Iterative Closest Point (ICP) algorithm to perform the registration.

Then, the map generation device 200 may update the pose of the second LiDAR based on the registration result (S214).

If the Root Mean Square (RMS) error between the registered point cloud data and the pre-generated map exceeds a predefined threshold, the map generation device 200 may perform motion correction for the second LiDAR (S215, S216). After that, the map generation device 200 may repeat the process of mapping newly collected point cloud data from the second LiDAR onto the pre-generated map (S212), registering the mapped point cloud data (S213), and updating the pose of the second LiDAR based on the registration result (S214).

Conversely, if the RMS error between the registered point cloud data and the pre-generated map is less than the predefined threshold, the map generation device 200 may terminate the calibration process between the LiDARs.

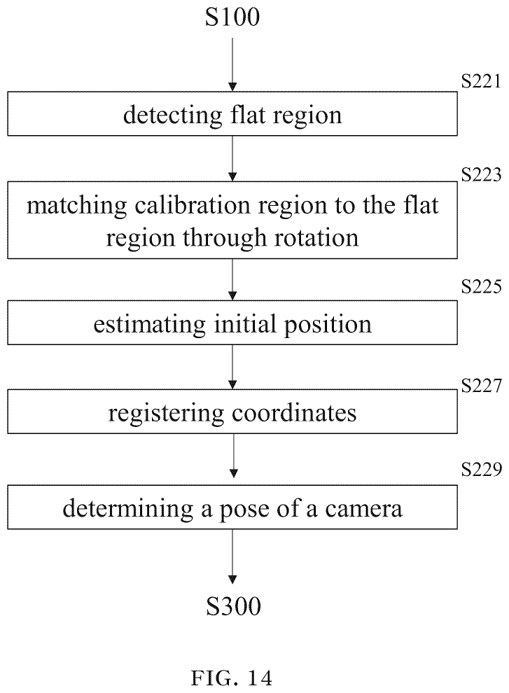

FIG. 14 is a flowchart for explaining a method of calibrating between a camera and a LiDAR according to an embodiment of the disclosure.

As illustrated in FIG. 14, the map generation device 200 may detect flat regions corresponding to a calibration board from each of a plurality of point cloud data acquired by the LiDAR (S221). In this case, the LiDAR and the camera of the data acquisition device 100 may acquire point cloud data and capture images, respectively, while remaining stationary, with respect to a calibration board whose position moves over time. The acquired point cloud data and captured images may be grouped into a single dataset based on the respective acquisition time points.

The map generation device 200 may rotate the region corresponding to the calibration board, identified from the image, in three-dimensional space so that the region corresponding to the calibration board overlaps with the flat region as closely as possible (S223). For example, the map generation device 200 may rotate the region corresponding to the calibration board by varying roll, pitch, and yaw angles from 1 to 360 degrees to maximize the overlap of the region corresponding to the calibration board with the flat region.

Based on the result of matching the region corresponding to the calibration board and the flat region in the point cloud data, the map generation device 200 may estimate the initial position of the calibration board in three-dimensional coordinates (S225).

The map generation device 200 may register the coordinates of the initial position of the calibration board with the coordinates of the flat region (S227). In this case, the map generation device 200 may use an Iterative Closest Point (ICP) algorithm to perform the registration.

Then, the map generation device 200 may determine the pose of the camera based on the registered coordinates (S229). Specifically, the map generation device 200 may calculate the rotation matrix and the translation matrix (RT) of the camera based on the registered coordinates.

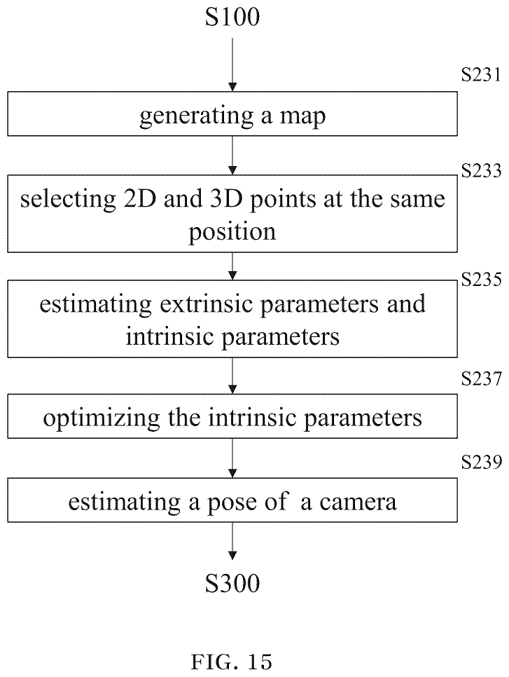

FIG. 15 is a flowchart for explaining a method of estimating and optimizing camera parameters according to an embodiment of the disclosure.

As illustrated in FIG. 15, the map generation device 200 may generate a map based on previously collected point cloud data using Simultaneous Localization and Mapping (SLAM) (S231). However, this is not limiting, and the map generation device 200 may alternatively generate the map based on a Mobile Mapping System (MMS).

The map generation device 200 may select a three-dimensional (3D) point from the point cloud data constructing the map and a two-dimensional (2D) point from the images constructing the map (S233). In this case, the 3D point and the 2D point may indicate the same physical location.

The map generation device 200 may estimate the extrinsic parameters of the camera based on the condition that the selected 3D point is projected onto the 2D point. In addition, the map generation device 200 may estimate the intrinsic parameters of the camera based on the condition that the 2D point is projected onto the image plane (S235). Specifically, the map generation device 200 may construct a matrix to transform the world coordinates of the 3D point into the camera coordinates of the 2D point and estimate the extrinsic parameters based on the constructed matrix. Furthermore, the map generation device 200 may construct a matrix to transform the camera coordinates of the 2D point into image coordinates on the image and estimate the intrinsic parameters based on the constructed matrix.

The map generation device 200 may select new 3D and 2D points from the point cloud data and the image. In this case, while it may be unclear whether the new 3D and 2D points indicate the same exact location, they may correspond to similar positions. The map generation device 200 may then optimize the previously estimated intrinsic parameters so that the new 2D point can be accurately projected onto the image plane (S237).

Finally, the map generation device 200 may estimate the pose of the camera based on the estimated and optimized extrinsic and intrinsic parameters (S239).

As described above, although preferred embodiments of the present disclosure have been disclosed in the specification and drawings, it will be apparent to those skilled in the art that various modifications may be made without departing from the spirit and scope of the present invention.

Additionally, while specific terms may have been used in the specification and drawings, such terms have been used merely to facilitate explanation of the technical content of the invention and to assist understanding, and are not intended to limit the scope of the present invention.

Accordingly, the above detailed description should not be construed as limiting but rather as illustrative in all respects. The scope of the present invention should be defined by reasonable interpretation of the appended claims, and all modifications falling within the equivalent scope of the claims are to be construed as being included within the scope of the present invention.

What is claimed is:

1. A method of performing calibration, the method comprising:
detecting, with respect to a calibration board, a flat region corresponding to the calibration board from each of two or more point cloud data obtained by LiDAR;
identifying a region corresponding to the calibration board from each of two or more images captured by a camera at respective acquisition time points of the point cloud data;
estimating an initial position of the calibration board in three-dimensional coordinates by matching the region corresponding to the calibration board with the flat region;
registering coordinates of the initial position of the calibration board with coordinates of the flat region; and
determining a pose of the camera based on the registered coordinates;
wherein estimating the initial position of the calibration board comprises:
rotating the region corresponding to the calibration board in three-dimensional space by aligning the region corresponding to the calibration board with the flat region;
calculating a center of gravity of the flat region by using a state in which the region corresponding to the calibration board is rotated to maximally overlap with the flat region; and
estimating the initial position of the calibration board by using the calculated center of gravity;
wherein registering the coordinates comprises:
registering the coordinates of the initial position of the calibration board with the coordinates of the flat region by using an Iterative Closest Point (ICP) algorithm; and
registering, selectively, four coordinates corresponding to corners of the calibration board with four coordinates corresponding to corners of the flat region among the coordinates of the initial position of the calibration board;
wherein determining the pose of the camera comprises:
calculating a rotation matrix and a translation matrix of the camera by using only the four registered coordinates.

2. The method of claim 1,
wherein the LiDAR acquires the point cloud data, with respect to the calibration board whose position changes sequentially over time, while the LiDAR remains in a fixed position;
wherein the camera captures the images, with respect to the calibration board whose position changes sequentially over time, while the camera remains in a fixed position;
wherein the point cloud data and the images construct a single data set based on a time point at which point cloud data is acquired by the LiDAR and images are captured by the camera.

3. The method of claim 2, wherein detecting the flat region comprises:
selecting each of the two or more point cloud data from two or more datasets constructed at different time points among a plurality of consecutively configured datasets in time series.

4. The method of claim 3, wherein detecting the flat region comprises:
selecting only the point cloud data acquired simultaneously with the image in which the calibration board does not exhibit motion blur.

5. The method of claim 1, wherein detecting the flat region comprises:
detecting each flat region by performing a Boolean operation between the two or more point cloud data.

6. The method of claim 5, wherein detecting the flat region comprises:
detecting only coordinates corresponding to the flat region by performing Random Sample Consensus (RANSAC) on a result of the Boolean operation.

7. The method of claim 1, wherein estimating the initial position of the calibration board comprises:
rotating the region corresponding to the calibration board by varying roll, pitch, and yaw angles from 1 degree to 360 degrees so that the region overlaps maximally with the flat region.

8. The method of claim 1, wherein registering the coordinates comprises:
calculating an error rate between the four coordinates corresponding to corners of the calibration board and the four coordinates corresponding to corners of the flat region during registration using only the four corner coordinates; and
registering the coordinates of the initial position of the calibration board with the coordinates of the flat region when the error rate exceeds a predefined threshold.

9. A map generation device for performing calibration, the map generation device comprising:
a memory;
a transceiver; and
a processor configured to execute instructions stored in the memory,
wherein the processor is configured to:
detect, with respect to a calibration board, a flat region corresponding to the calibration board from each of two or more point cloud data obtained by LiDAR;
identify a region corresponding to the calibration board from each of two or more images captured by a camera at respective acquisition time points of the point cloud data;
estimate an initial position of the calibration board in three-dimensional coordinates by matching the region corresponding to the calibration board with the flat region;
register coordinates of the initial position of the calibration board with coordinates of the flat region; and
determine a pose of the camera based on the registered coordinates;
wherein estimating the initial position of the calibration board comprises:
rotate the region corresponding to the calibration board in three-dimensional space by aligning the region corresponding to the calibration board with the flat region;
calculate a center of gravity of the flat region by using a state in which the region corresponding to the calibration board is rotated to maximally overlap with the flat region; and
estimate the initial position of the calibration board by using the calculated center of gravity;
wherein registering the coordinates comprises:
register the coordinates of the initial position of the calibration board with the coordinates of the flat region by using an Iterative Closest Point (ICP) algorithm; and
register, selectively, four coordinates corresponding to corners of the calibration board with four coordinates corresponding to corners of the flat region among the coordinates of the initial position of the calibration board;
wherein determining the pose of the camera comprises:
calculating a rotation matrix and a translation matrix of the camera by using only the four registered coordinates.

10. The map generation device of claim 9,
wherein the LiDAR acquires the point cloud data, with respect to the calibration board whose position changes sequentially over time, while the LiDAR remains in a fixed position;
wherein the camera captures the images, with respect to the calibration board whose position changes sequentially over time, while the camera remains in a fixed position;
wherein the point cloud data and the images construct a single data set based on a time point at which point cloud data is acquired by the LiDAR and images are captured by the camera.
